(19) United States
(12) Patent Application Publication
(10) Pub. No.: US 2026/0290154 A1
(43) Pub. Date: Sep. 24, 2026

(54) Computer System and Computer-Implemented Method For Detecting, Routing and Reporting Incidents at Traffic Intersections

(71) Applicant: Miovision Technologies Incorporated, Kitchener (CA)

(72) Inventors: Cody DOERFLER, Westminster, CO (US); Mary Adelaide DENISON, Toronto (CA); David HILLIS, Kitchener (CA); Jason DEGLINT, Kitchener (CA)

(73) Assignee: Miovision Technologies Incorporated, Kitchener (CA)

(21) Appl. No.: 19/569,694

(22) Filed: Mar. 17, 2026

Related U.S. Application Data
(60) Provisional application No. 63/774,351, filed on Mar. 19, 2025.

(51) Int. Cl. G08G 1/01; G08G 1/07; G08G 1/16; H04W 4/44; H04W 4/90

(52) U.S. Cl. CPC G08G 1/0133; G08G 1/0116; G08G 1/0141; G08G 1/0145; G08G 1/07; G08G 1/164; G08G 1/166; H04W 4/44; H04W 4/90

(57) ABSTRACT

System and method of incident detection at monitored traffic areas. The method includes detecting one or more events using data acquired by one or more sensors at a monitored area and using the sensor data to identify an incident associated with an event. The method also includes generating a notification associated with the incident and using the notification to establish communication with an emergency service.

### CROSS-REFERENCE TO RELATED APPLICATIONS

This application claims priority to U.S. Provisional Patent Application No. 63/774,351 filed on March 19, 2025, the contents of which are incorporated herein by reference.

### TECHNICAL FIELD

The following generally relates to incident monitoring and, more particularly, to detecting, routing and reporting incidents such as crashes at traffic intersections.

### BACKGROUND

Currently, when a vehicle collision or accident or other incident occurs on a roadway or at an intersection, a victim, bystander or witness reports the incident to an emergency service or law enforcement authority at some point following the incident. This can create a meaningful delay before a call is made and a responder dispatched, thus wasting precious time.

While certain in-vehicle navigation systems are capable of automating an emergency call, if they detect a crash (e.g., OnStar®), not all vehicles are equipped with such devices, making the solution inequitable or at least inconsistent or incomplete.

### SUMMARY

The following addresses challenges such as those discussed above by providing a consistent and reliable reporting solution in the field, which can notify an emergency contact point such as 911 when the incident occurs, regardless of who/what is involved and what communication tools are available to them.

In one aspect, there is provided a method of incident detection at monitored traffic areas, the method comprising detecting one or more events using data acquired by one or more sensors at a monitored area; using the sensor data to identify an incident associated with an event; generating a notification associated with the incident; and using the notification to establish communication with an emergency service.

In certain example embodiments the notification is generated from an information package, the information package comprising data associated with the incident and determined from the sensor data.

In certain example embodiments, the sensor data comprises video or image data.

In certain example embodiments the method includes using an incident model to identify the incident.

In certain example embodiments, the notification is sent to a 911 service provider to determine whether to dispatch an emergency service.

In certain example embodiments, the method further includes generating incident details for a subsequent incident report.

In certain example embodiments, the method further includes receiving an instruction and executing an action at the monitored area based on the instruction.

In certain example embodiments, the instruction comprises a traffic signal operation.

In certain example embodiments, the notification enables the incident to be validated and transferred to a computer aided dispatch (CAD) system.

In certain example embodiments, a V2X message is generated and sent to a plurality of devices that may be affected by the incident.

In certain example embodiments, identifying the incident comprises using a crash detection computer vision model to analyze video included in the sensor data.

In certain example embodiments, the method further includes obtaining at least one additional model to determine classification details.

In certain example embodiments, the sensor data is received and processed by a centralized incident monitoring system.

In another aspect, there is provided a computer readable medium storing computer executable instructions for incident detection at monitored traffic areas, comprising instructions for performing the methods above.

In another aspect, there is provided a computer system comprising a processor and memory, the memory storing computer executable instructions for incident detection at monitored traffic areas, comprising instructions for performing the methods above.

### BRIEF DESCRIPTION OF THE DRAWINGS

Embodiments will now be described with reference to the appended drawings wherein:

FIG. 1a is a schematic diagram of an incident monitoring system connected to a series of computing devices deployed at a series of intersections in a traffic network.

FIG. 1b is a schematic diagram of a series of computing devices at a series of intersections connected directly to a 911 service provider.

FIG. 2a is a block diagram of a computing device coupled to an incident monitoring system.

FIG. 2b is a block diagram of a computing device coupled to a 911 service provider.

FIG. 3 is a block diagram of a video capture device coupled to or integrated in a computing device at an intersection.

FIG. 4 illustrates data flows between in field systems and a 911 service provider to initiate actions by a computer-aided dispatch (CAD) for dispatching emergency responders.

FIG. 5 is a block diagram of a computing system that may be used to implement the intersection computing devices and/or the incident monitoring system.

FIG. 6 is a flow chart illustrating operations performed in generating an information package to be sent to a 911 service provider or other entity.

FIG. 7 is a flow chart illustrating operations performed in processing an information package by a 911 service provider.

FIG. 8 is a flow chart illustrating operations performed in identifying an incident associated with an event.

### DETAILED DESCRIPTION

In addition to 911 reporting near a roadway or at an intersection, computer vision may be used to track road user movements through an intersection. This information can be used to generate “near miss” events that can be used by road safety engineers to analyze road safety and possibly make improvements to the intersection or signal timing, etc. The computer vision data provides track-paths for road users, the times the paths cross, the speed of road users, and the relative sizes of vehicles. This information may be used to generate details on the potential severity of the near miss. However, this data is not typically provided in real-time but instead used for after-the-fact analyses.

It is recognized that humans are historically found to mostly be inaccurate when placing emergency calls, such as by dialing 911. For example, times, locations, and other details of the incident are misreported, forgotten or overlooked. This can result in possible delays or inappropriate emergency responses. Such calls that are placed by humans can be delayed, particularly when the only persons available to report the incident are those involved in a crash or collision. Moreover, near miss analytics is seen to be a preventative measure (post-event reporting) that provides information after the fact. While potential valuable as part of an overall information strategy, these analytics may not be suitable for emergency applications.

The following describes solutions for consistent real-time monitoring in the field to more quickly alert emergency services of incidents such as crashes, collisions or other accidents at intersections or other roadway areas. The solutions may include direct reporting from an intersection or roadway or centralized reporting via a monitoring system that is connected to intersections and roadways, e.g., as part of an intelligent traffic system (ITS).

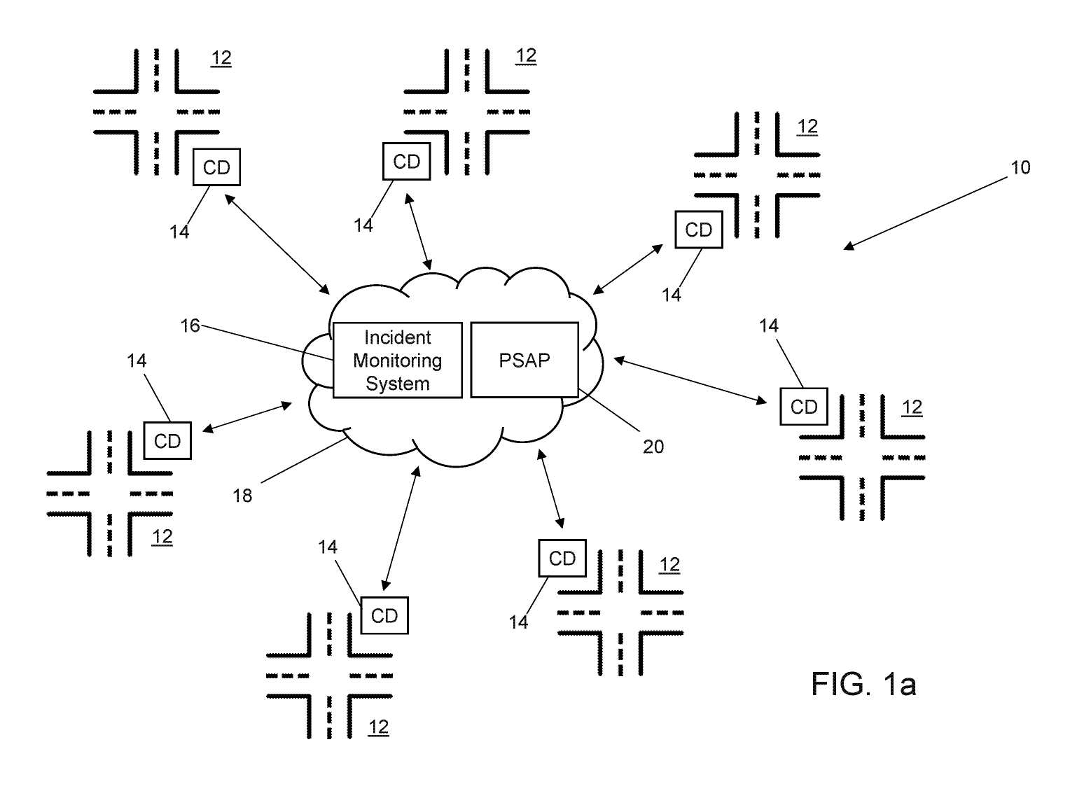

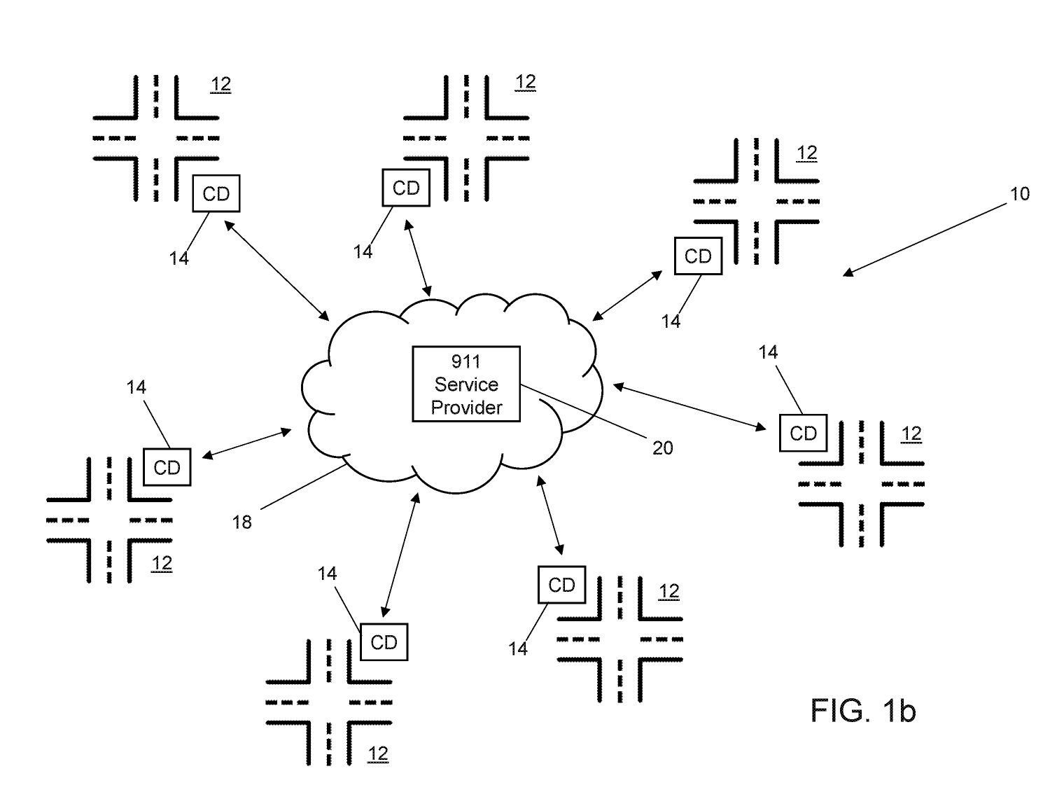

Turning now to the figures, FIG. 1a illustrates a monitoring and/or control system 10 (hereinafter also referred to as the “system” 10), which includes an incident monitoring system 16 and a 911 service provider 20 connected to a number of traffic areas such as roadways or intersections 12 via cloud-connected intelligent signaling computing devices (CDs) 14. The CDs 14 are connected to the incident monitoring system 16 (and/or 911 service provider 20 – see FIG. 1b) via one or more communication networks 18.

Communication network(s) 18 may include a telephone network, cellular, and/or data communication network to connect different types of devices, including the CDs 14. For example, the communication network(s) 18 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

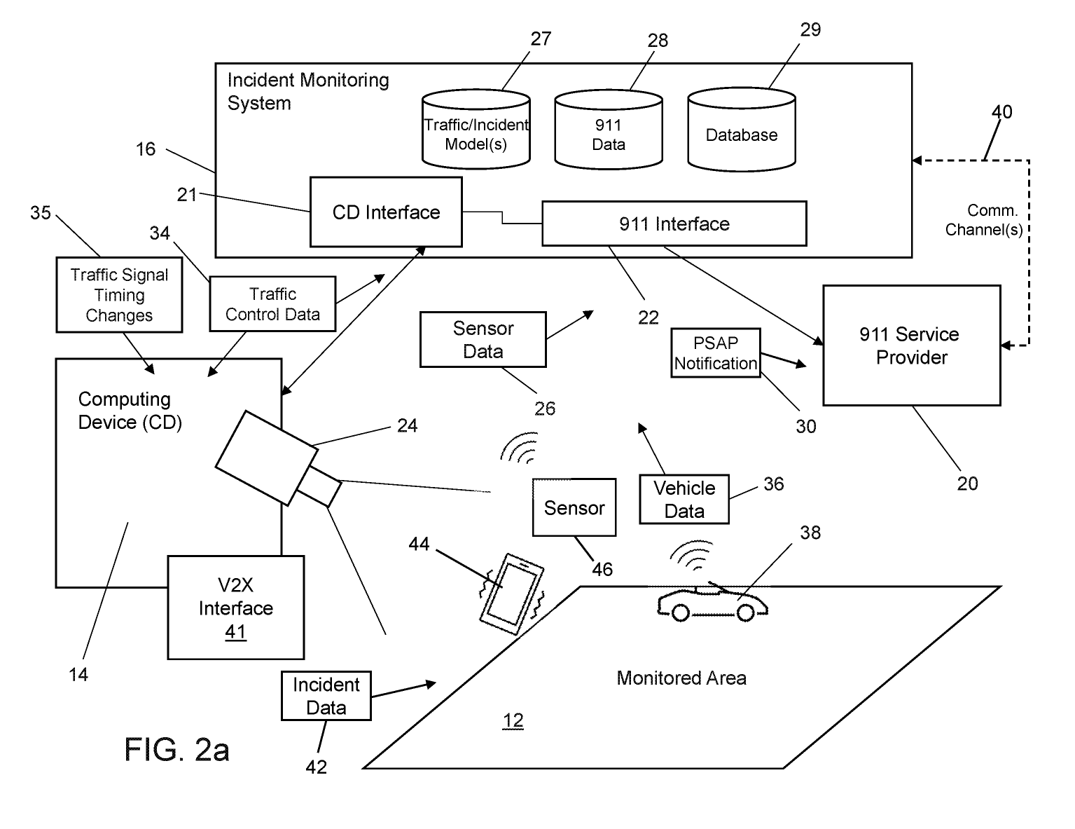

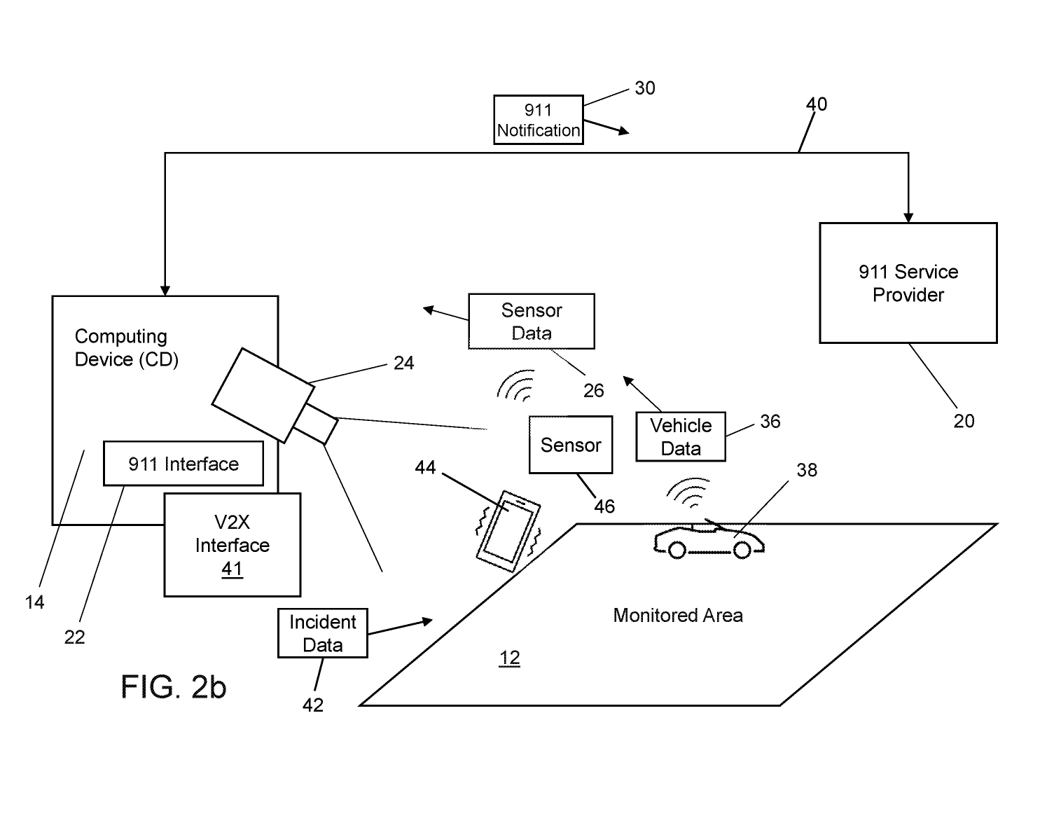

Each CD 14 in this example can include one or more video capture devices 24 (see also FIGS. 2a and 2b) for capturing video associated with a monitored area associated with the corresponding intersection 12. The connectivity shown in FIG. 1a enables the incident monitoring system 16 to bi-directionally communicate with the CDs 14 and to send or receive data to/from the CDs 14, e.g., sensor (incl. camera) data 26, traffic control data 34, and traffic signal timing changes 35, vehicle data 36, and incident data 42 as illustrated in FIGS. 2a and 2b.

FIG. 1b illustrates that the CDs 14 may be configured to communicate directly with the 911 service provider 20 and thus the incident monitoring system 16 shown in FIG. 1a is optional and may be used to provide a centralized, cloud-based service coupled to many intersections 12 and other roadway areas to provide intelligent monitoring and control, e.g., to coordinate signal timing changes 35 or other instructions sent to the intersection 12.

Turning now to FIG. 2a, illustrated is a configuration in which the system 16 can be deployed, namely by leveraging the connectivity of an ITS or other cloud-based system (not shown) used for monitoring, analyzing, and/or controlling elements of or in a monitored area 12, e.g., a traffic intersection using video captured at or near the monitored area 12. It can be appreciated that the configuration and delineations between components shown in FIG. 2a are illustrative and other configurations and delineations are possible. A video capturing device 24, such as a camera or other device having a camera captures images and/or video to generate camera data associated with the monitored area 12. The camera data may be combined or packaged with other data acquired at the monitored area (e.g., from one or more sensors 46) to create a set of sensor data 26 that may be sent to the incident monitoring system 16. The sensor data 26 can be locally stored by the video capture device 24 (e.g., using an internal or externally coupled storage device).

The sensor data 26 can also be transmitted over a communication channel to a cloud system, e.g., a processing server, network infrastructure, etc. In this example, the cloud system is a cloud-based incident monitoring system 16 having a CD interface 21. The communication channel between the video capture device 24 and the system 16 can be direct or via the CD 14 and may include a wired, wireless, or manual delivery channel capable of transporting the sensor data 26 from the video capture device 24 and/or sensors 46 to the system 16 for subsequent usage and/or processing. For example, a cellular network can be used for wireless transmission, a fiber optic network can be used for wired transmission, and a portable media device (e.g., universal serial bus (USB) drive) can be used for manual transportation of the sensor data 26.

The system 16 in this example may also include a 911 interface 22, which is used to communicate 911 notifications 30 to the 911 service provider 20. The 911 service provider 20 may have one or more communication channels 40, e.g., for enabling two-way communications between operators at the 911 service provider 20 and operators or entities in the incident monitoring system 16, e.g., to initiate the creation and provision of traffic control data 34, traffic signal timing changes 35, et. The system 16 can also obtain or receive other types of data such as vehicle data 36 generated and transmitted from a vehicle 38 (including both connected and unconnected and/or autonomous vehicles) that is associated with the monitored area 12 (e.g., by passing or turning through an intersection in the monitored area 12) and other data that can be provided by various third party sources and services (not shown), in order to determine other factors that can contribute to monitoring and analyses. The system 16 can store one or more incident or traffic models 27, 911 data 28 (e.g., data logs, transcriptions, recording or other records related to 911 notifications 30 and/or communications with the 911 service provider 20), and/or include a database 29 for storing other data, such as sensor data 26 or vehicle data 36. The system 16 may include or utilize capabilities of an ITS to provide a platform for sending and receiving traffic control data 34 to optimize signaling and timing parameters for the CDs 14 to, for example, react to the detection of and response to incidents detected at the monitored area 12. As shown in FIG. 2a, traffic signal timing data 35 can be sent by the system 16 to the CD 14. The system 16 (or a related ITS) can therefore be leveraged to perform monitoring and optimization operations in addition to its existing operations related to intelligent traffic monitoring and control. The data gathered and analyzed as illustrated in FIG. 2a may also be used for indirectly determining optimizations, e.g., by changing traffic signal timing. Also shown in FIG. 2a is a V2X interface 41, which may be used to obtain V2X-related data from vehicles 38 or user devices 44 at the intersection, which may be coupled with the sensor data 26 or vehicle data 36 or may be included in separate V2X packets (not shown) or other communications. The V2X-related data can take any form made available via the V2X system 60, for example, speed, heading, direction, G forces or other impact-related data, ABS signals, hazards, airbag deployment or other attributes. This may be supplemental for emergency responders or can be ignored if not useful. The V2X-related data may be fused with the other sources of data or augmented as needed. As noted, data may be ignored or discarded if not needed or found useful.

FIG. 2b illustrates a configuration similar to that shown in FIG. 2a, for the implementation illustrated in FIG. 1b, namely where the CD 14 is in direct communication with the 911 service provider 20. In this configuration, 911 notifications 30 may be sent to the 911 service provider 20 via the 911 interface 22 integrated into the CD 14 and/or video capture device 24. The communication channel(s) 40 may be established between the 911 service provider 20 and the CD 14 in this example to enable potential two-way communications between the 911 service provider 20 and control systems at the CD 14 or operators that have arrived at the monitored area 12 and have control over a CD 14. The 911 service provider 20 may be a third party that handles communications with another emergency services entity such as a public safety answer system (PSAP) – not shown, or with multiple PSAPs wherein the 911 service provider 20 can determine which is the most appropriate PSAP to communicate with based on where the monitored area 12 is located.

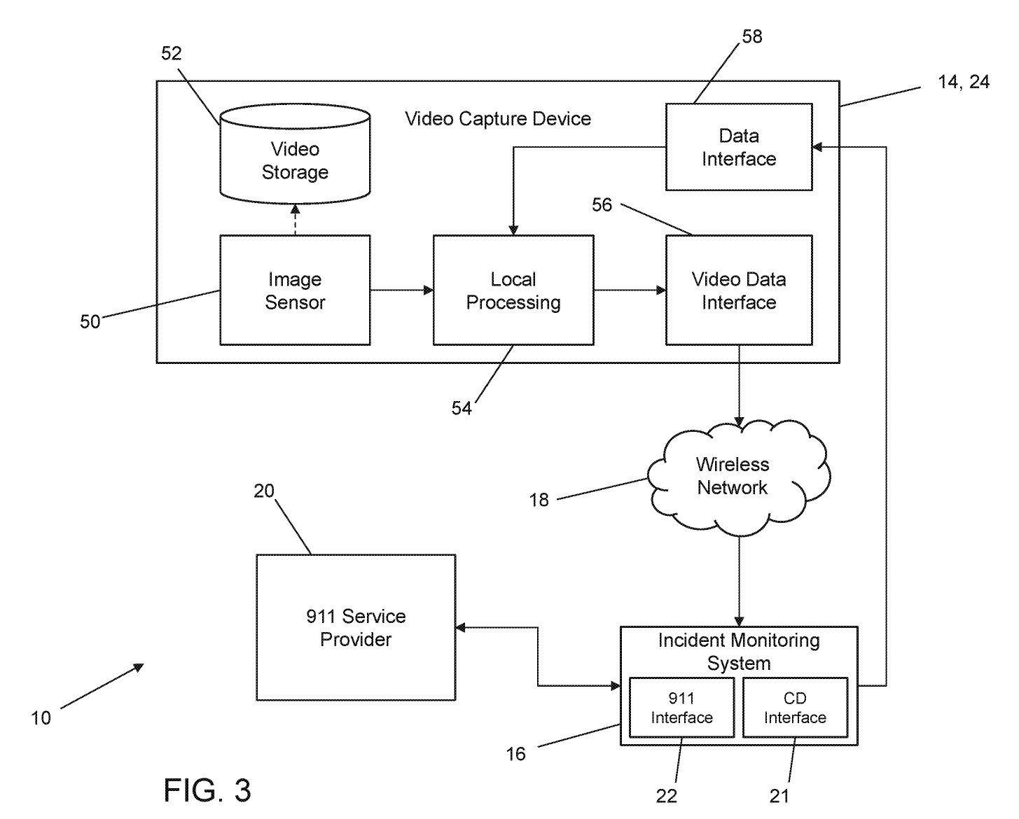

FIG. 3 illustrates one illustrative example of a configuration for the video and image capture device 24. In this example, the video capture device 24 includes an image sensor 50 for capturing a series of images to generate the frames of a video, a local video storage module 52, and a local processing module 54 for performing local processing functions such as object of interest extraction, compression, etc. The local processing module 54 can also use a video data interface 56 to send video to the system 16 (or 911 service provider 20) via a wireless network 18. As shown in FIG. 3, the video capture device 24 can also include a data interface 58 for receiving communications and/or data from, among other things, the system 16. It can be appreciated that the video data interface 56 and data interface 58 are shown as separate components for illustrative purposes only and both modules and/or functionalities can be implemented using a single device, e.g., a transceiver configured to wirelessly transmit video data and to wirelessly receive configuration or update data via one or more wireless networks 18.

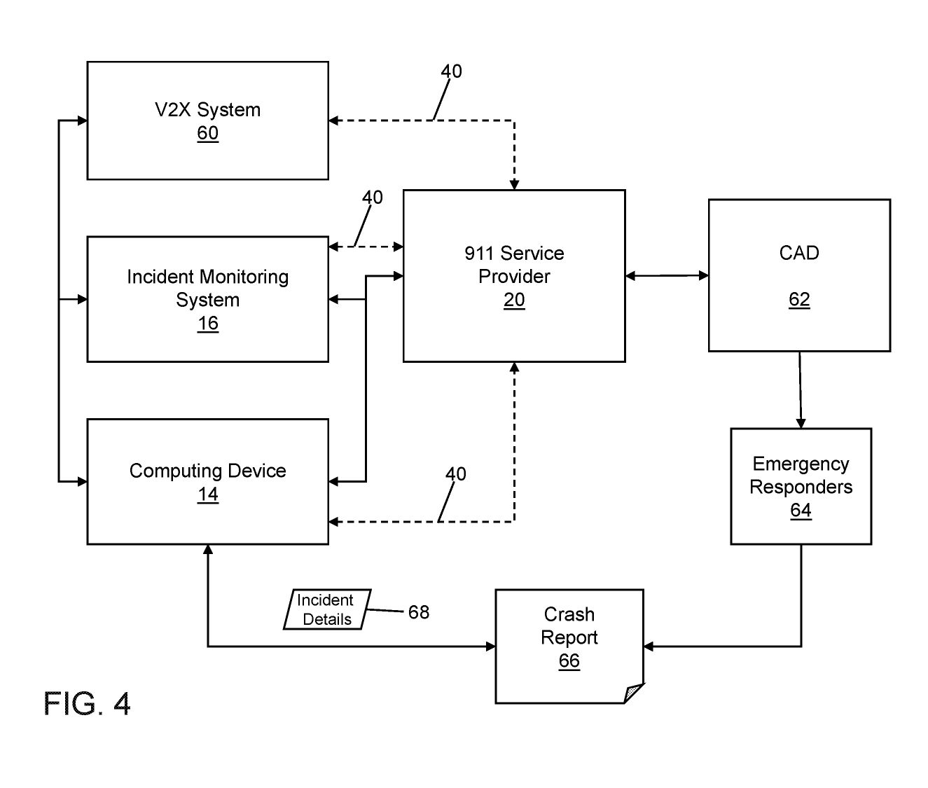

Referring now to FIG. 4, example connections to permit various data flows are shown. In this example, the 911 service provider 20 may receive data from either or both the incident monitoring system 16 and the CD 14. As noted above, the 911 service provider 20 may be in direct communication with the CAD 62 or may act a third party in between the present system and one or more PSAPs. Optionally, a V2X system 60 may communicate with the 911 service provider 20, e.g., via one of the communication channels 40. The communication channel(s) 40 may additionally be used to permit the 911 service provider 20 to communicate back to the system 16 and/or CDs 14 as discussed above. This enables a feedback loop to be established between various parties in the system to share video, images/snapshots and other data. The feedback data may be used to train the models over time based on the outcomes of the emergency responses and what data was used or deemed relevant. The feedback loops (e.g., shown in dashed lines) also enable two-way communications, follow ups, authentication loops and other dialogue or exchanges related to an incident or event to occur after the fact.

The 911 service provider 20 is positioned to determine if the detected incident requires an emergency dispatch, similar to how a traditional 911 call is answered and processed. By communicating directly with the system 16 and/or CD 14, the 911 service provider 20 may obtain additional incident details 68 such as video footage at the time of the incident, still images, etc. The 911 service provider 20 may then communicate with a CAD 62, which in turn dispatches emergency responders 64, such as police, fire, ambulance, etc. The emergency responders 64 may be tasked with generating a crash report 66 (e.g., police report) after an investigation and the incident details 68 generated by the CD 14 at the monitored area 12 may be used to automated, semi-automated or augmented reporting, including the inclusion of media files.

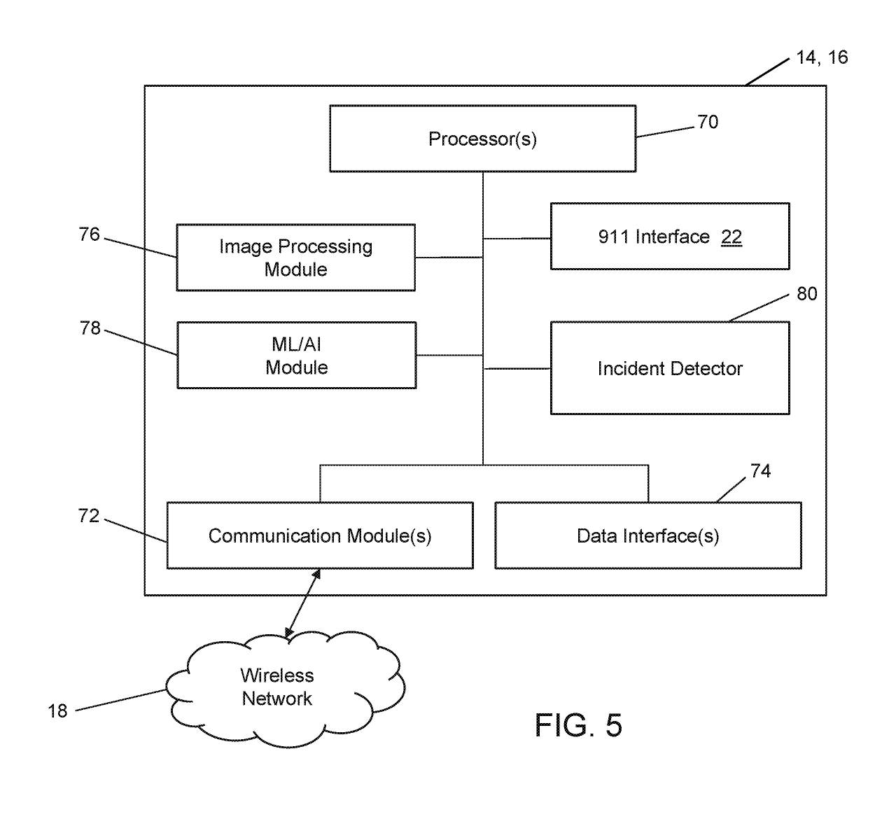

In FIG. 5, an example configuration of a computing device or system used to implement the CD 14 or system 16 is shown. In certain embodiments, the CD 14 or system 16 may include one or more processors 70, a communications module 72, and a data interface module 74 for interfacing with databases or other data storage modules, incident/traffic model(s) 27, and/or 911 data 28, and/or database 29, and/or vehicle data 36, traffic control data 34, sensor data 26, and traffic signal timing changes 35, etc. The system 16 can be embodied as one or more server devices and/or other computing device(s) configured to operate within the system 10. It can be appreciated that at least some pre-processing can be done by the video capture device 24 and the configurations shown in FIGS. 2-4 are illustrative only. Communications module 72 enables the system 16 to communicate with one or more other components of computing environments associated with the system 10, such as CDs 14, the 911 service provider 20 and embedded or other computing devices on-board vehicles 38, via a bus or other communication network, such as the communication network 18. While not delineated in FIG. 5, the CD 14 or system 16 includes at least one memory or memory device that can include a tangible and non-transitory computer-readable medium having stored therein computer programs, sets of instructions, code, or data to be executed by processor 50. FIG. 5 illustrates examples of modules, tools and engines stored in memory on the CD 14 or system 16 and executed by the processor 70. It can be appreciated that any of the modules, tools, and engines shown in FIG. 5 may also be hosted externally and be available to the CD 14 or system 16, e.g., via the communications module 72. In the example embodiment shown in FIG. 5, the CD 14 or system 16 includes an image processing module 76, for example, to enable the CD 14 or system 16 to detect vehicle type, speed, and directionality from the camera data 26.

The CD 14 or system 16 can also include a machine learning (ML)/artificial intelligence (AI) module 78 that can be utilized with the image processing module 76 or with other functionality, e.g., to generate, improve, or utilize incident/traffic models 27, or related models, e.g., to determine traffic signaling and timing that can initiate a suitable response at the intersection 12 or network of intersections 12 (e.g., by controlling traffic signals, traffic timing, etc.). The data used by the ML/AI module 78 can be used to improve the analyses conducted by the system 10. For example, the more vehicles seen by the system 10 can be used to improve the models used to recognize specific vehicle models, years, makes, etc.(i.e. from training data generated by the cameras).

The system 10 can be deployed within a project to apply the methodology described herein through the deployment of hardware and software that collect high-resolution traffic signal and multi-modal detection data across a traffic network; and analyze the traffic signal and multi-modal sensor data to produce frequent and high-quality performance measures and operational insights that facilitate traffic signal optimization.

Using these inputs the traffic model 27 provides the necessary inputs for determining, for example, Traffic Performance Metrics (TPMs). TPMs characterize how vehicles travel through the project’s boundaries. This can include the total number of vehicles that stop at each intersection, the total number of vehicles that arrive on green or red lights, and can include more detailed data such as per-second trajectories outlining the speed and acceleration of the vehicles in the network.

The various interface module(s) shown in FIG. 5 can take the form of an application programming interface (API), software development kit (SDK) or any other software, plug-in, agent, or tool that allows the CD 14 or system 16 to be integrated with or within an application associated with another entity, such as an ITS (not shown), 911 service provider 20, etc. The CD 14 or system 16 may also include a PSAP interface 22 (e.g., as shown in FIGS. 2a and 2b) and an incident detector 80. The incident detector 80 may utilize the ML/AI module 78 to infer an incident from a trained incident model 27. The system 16 may, additionally or alternatively, utilize multiple incident models 27 or multiple models in which one is an incident model 27. That is, a hybrid model or multi-model approach may be used to utilize a base model with additional model(s) trained to detect specific incidents or to more accurately detect incidents for specific types of monitored areas such as traffic intersections versus straight roadways, versus railway crossings, etc.

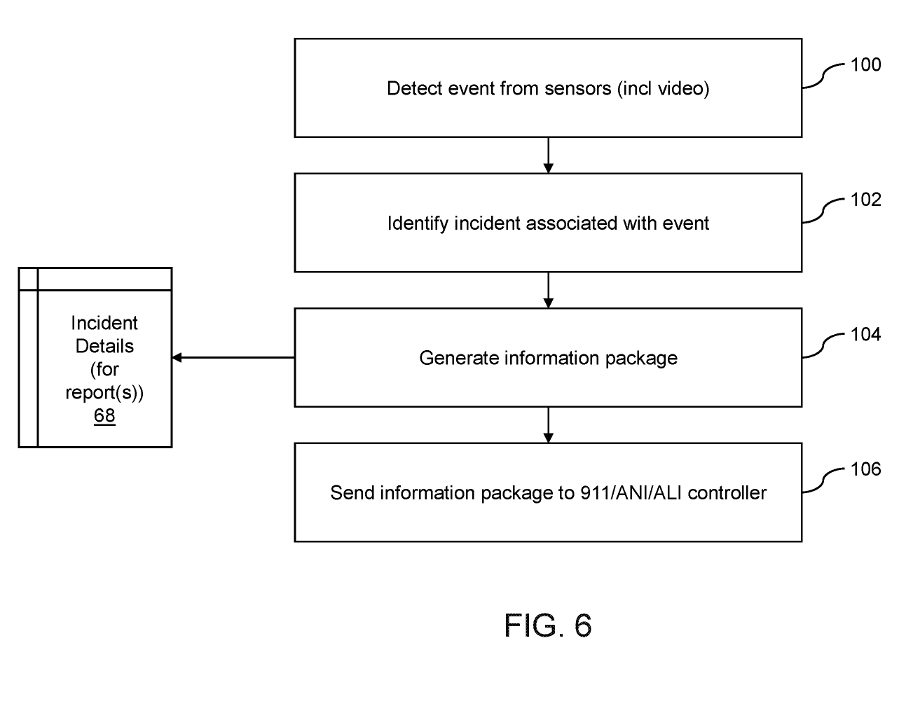

Referring now to FIG. 6, a flow chart is provided illustrating operations that may be performed in generating an information package to be sent to a 911 service provider 20 or other entity, e.g., as a 911 notification 30 shown in FIGS. 2a and 2b.

At block 100, an event is detected using the sensors 46 and/or video capture device 24 (which itself may be considered a sensor 46). For example, video being monitored by the CD 14 may detect that an event has occurred. At block 102, the CD 14 or system 16 may identify an incident associated with the event. For example, detecting an event associated with a number of vehicles being stopped in an intersection may trigger an event analysis but be found to be related to construction or weather rather than being associated with a crash or collision. However, if a crash, collision or other incident is detected at block 102, the system 16 (or CD 14) may generate an information package at block 104, which may include incident details 68 that can be used for a later report as well as a PSAP notification 30.

At block 106, the information package may be used to communicate with an emergency-related entity such as the 911 service provider 20, or an ANI or ALI controller. For example, as shown in FIGS. 2a and 2b, a PSAP notification 30 may be used to initiate an emergency reporting process to enable the 911 service provider 20 to triage and determine whether to trigger a CAD 62 to dispatch emergency responder(s) 64.

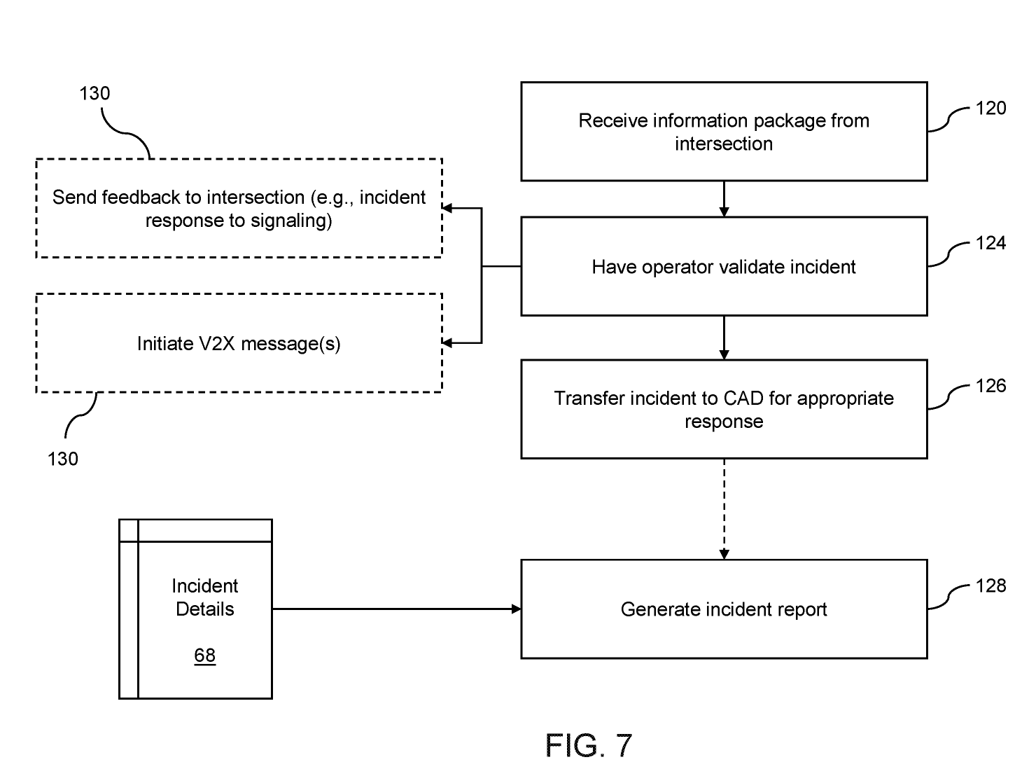

FIG. 7 provides a flow chart illustrating operations performed in processing an information package by a 911 service provider 20. At block 120, the 911 service provider 20 receives an information package, e.g., via a PSAP notification 30 generated at the intersection 12. At block 122, an operator at the 911 service provider 20 may validate the incident based on the data provided in the notification 30 or via additional media or other files transferred to the 911 service provider 20. For example, the PSAP notification 30 may be used to allow an operator at the 911 service provider 20 to select a link or create a connection to receive additional information such as live or stored footage at the intersection.

At block 126, the PSAP operator may then transfer the incident to the CAD 62 for an appropriate response, which may include contacting and dispatching an emergency responder 64. At block 128, an incident report may be generated by the entity responsible for doing so and this can include obtaining incident details 68 from the system 16 or CD 14.

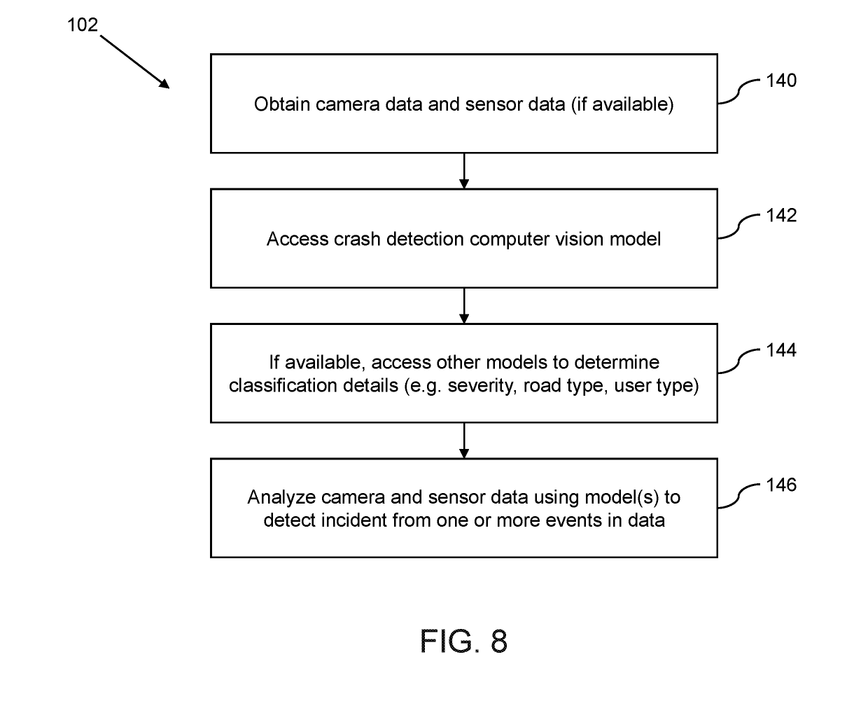

Referring now to FIG. 8, a flow chart is provided illustrating operations performed in identifying an incident associated with an event, e.g., as part of block 102 shown in FIG. 6. At block 140, the camera data and/or other sensor data 26 (if available), may be obtained. At block 142, a crash detection computer vision model 27 is accessed. If available, other models 27 may be used at block 144 to determine classification details (e.g., severity, road type, user type, etc.). At block 146, the camera and sensor data 26 may be analyzed using the model(s) 27 to detect an incident from one or more events detected in the data.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A method of incident detection at monitored traffic areas, the method comprising:
detecting one or more events using data acquired by one or more sensors at a monitored area;
using the sensor data to identify an incident associated with an event;
generating a notification associated with the incident; and
using the notification to establish communication with an emergency service.

2. The method of claim 1, wherein the notification is generated from an information package, the information package comprising data associated with the incident and determined from the sensor data.

3. The method of claim 1, wherein the sensor data comprises video or image data.

4. The method of claim 1, further comprising using an incident model to identify the incident.

5. The method of claim 1, wherein the notification is sent to a 911 service provider to determine whether to dispatch an emergency service.

6. The method of claim 1, further comprising generating incident details for a subsequent incident report.

7. The method of claim 1, further comprising receiving an instruction and executing an action at the monitored area based on the instruction.

8. The method of claim 7, wherein the instruction comprises a traffic signal operation.

9. The method of claim 1, wherein the notification enables the incident to be validated and transferred to a computer aided dispatch (CAD) system.

10. The method of claim 1, wherein a V2X message is generated and sent to a plurality of devices that may be affected by the incident.

11. The method of claim 1, wherein identifying the incident comprises using a crash detection computer vision model to analyze video included in the sensor data.

12. The method of claim 11, further comprising obtaining at least one additional model to determine classification details.

13. The method of claim 1, wherein the sensor data is received and processed by a centralized incident monitoring system.

14. A computer system comprising:
a processor; and
memory, the memory storing computer executable instructions for incident detection at monitored traffic areas, comprising instructions for:
detecting one or more events using data acquired by one or more sensors at a monitored area;
using the sensor data to identify an incident associated with an event;
generating a notification associated with the incident; and
using the notification to establish communication with an emergency service.

15. The computer system of claim 14, wherein the notification is generated from an information package, the information package comprising data associated with the incident and determined from the sensor data.

16. The computer system of claim 14, wherein the sensor data comprises video or image data.

17. The computer system of claim 14, further comprising instructions for using an incident model to identify the incident.

18. The computer system of claim 14, wherein the notification is sent to a 911 service provider to determine whether to dispatch an emergency service.

19. The computer system of claim 14, further comprising instructions for generating incident details for a subsequent incident report.

20. A computer readable medium storing computer executable instructions for incident detection at monitored traffic areas, comprising instructions for:
detecting one or more events using data acquired by one or more sensors at a monitored area;
using the sensor data to identify an incident associated with an event;
generating a notification associated with the incident; and
using the notification to establish communication with an emergency service.
